(19) United States
(12) Patent Application Publication
(10) Pub. No.: US 2014/0321581 A1
(43) Pub. Date: Oct. 30, 2014

(54) METHODS AND SYSTEMS TO DETECT THE OCCURRENCE OF ERRONEOUS DEMODULATED BITS FOR DECISION FEEDBACK DEMODULATION

(71) Applicant: QUALCOMM Incorporated, San Diego, CA (US)

(72) Inventors: Le Nguyen Luong, San Diego, CA (US); Eunmo Kang, San Diego, CA (US)

(73) Assignee: QUALCOMM Incorporated, San Diego, CA (US)

(21) Appl. No.: 14/039,376

(22) Filed: Sep. 27, 2013

Related U.S. Application Data
(60) Provisional application No. 61/815,684, filed on Apr. 24, 2013.

(51) Int. Cl. H04L 1/20

(52) U.S. Cl. CPC H04L 1/206
USPC 375/340

(57) ABSTRACT

Systems and methods to detect the occurrence of erroneous demodulated bits for decision feedback demodulation are disclosed. In one implementation, an apparatus for detecting demodulation bit errors of a plurality of modulated bits includes a memory component configured to store a first threshold and a second threshold. The apparatus further includes a processor coupled to the memory component, the processor configured to retrieve the first threshold and second threshold from the memory component and to determine a demodulation metric value for each of the plurality of modulated bits, the processor further configured to count the number of demodulation metric values that cross the first threshold and compare the second threshold to the number of demodulation metric values that cross the first threshold.

### RELATED APPLICATIONS

The present application for patent claims priority to Provisional Application No. 61/815,684 titled “METHODS AND SYSTEMS TO DETECT THE OCCURRENCE OF ERRONEOUS DEMODULATED BITS FOR DECISION FEEDBACK DEMODULATION,” filed Apr. 24, 2013, and assigned to the assignee hereof and hereby expressly incorporated by reference herein.

### FIELD

This application relates generally to wireless communications, and more specifically to systems and methods of demodulated bits error detection for Bluetooth wireless communication.

### BACKGROUND

Bluetooth is a type of wireless technology usually used for exchanging data between devices over short distances, for example, a personal area network (PAN). Although initially Bluetooth applications were used for communicating audio data (for example, a wireless headset) or pointing device movement/selection data (for example, a wireless mouse), currently Bluetooth is used for communicating files and other discrete data that requires error-free transmission to avoid data corruption.

To determine if data communicated using a Bluetooth protocol is error-free, a checksum or a cyclic redundancy check (CRC) can be used on a device receiving the data. However, the need of an improved physical layer (PHY) error detector becomes more important as the payload of packets communicated by Bluetooth increases because a 16-bit CRC that normally may be used to detect erroneous demodulated bits in Bluetooth is no longer sufficient resulting in passing erroneous demodulated bits (false positives).

Accordingly, new systems and methods are needed, for Bluetooth communications and for other communication schemes, to implement an improved PHY error detector to detect the occurrence of erroneous demodulated bits in the payload of communicated data.

### SUMMARY

A summary of sample aspects of the disclosure follows. For convenience, one or more aspects of the disclosure may be referred to herein simply as “some aspects.”

Methods and apparatuses or devices being disclosed herein each have several aspects, no single one of which is solely responsible for its desirable attributes. Without limiting the scope of this disclosure, for example, as expressed by the claims which follow, its more prominent features will now be discussed briefly. After considering this discussion, and particularly after reading the section entitled “Detailed Description” one will understand how the features being described provide advantages that include allowing for multicasting using Bluetooth wireless technologies.

One innovation of the disclosure provides an apparatus for detecting demodulation bit errors of a plurality of modulated bits. In some implementations, the apparatus includes a memory component (which may be referred to simply as “memory”) configured to store a first threshold and a second threshold, and a processor coupled to the memory, the processor configured to retrieve the first threshold and second threshold from the memory and to determine a demodulation metric value for each of the plurality of modulated bits, the processor further configured to count the number of demodulation metric values that cross the first threshold and compare the second threshold to the number of demodulation metric values that cross the first threshold. In some implementations, the processor is further configured to determine if an error exists in the demodulated bits based on the comparison of the second threshold to the number of demodulation metric values that cross the first threshold. In various implementations of an apparatus, processor, method or computer readable medium, the modulated bits are Gaussian Frequency-Shift Keying (GFSK) modulated bits, Differential Phase-Shift Keying (DPSK) modulated bits, Differential Quaternary Phase-Shift Keying (DQPSK) modulated bits, or Differential Encoded 8-Phase Shift Keying (D8PSK) modulated bits. In some implementations, the processor is further configured to weight the number of demodulation metric values that exceed the first threshold for bits in the plurality of modulated bits that form at least a portion of a header of communicated information represented by the plurality of modulated bits. In some implementations of an apparatus, processor, method, or computer readable medium, the plurality of modulated bits are modulated using Gaussian Frequency-Shift Keying (GFSK) modulation, and the processor may be further configured to use a demodulation metric Z(N) as illustrated in the following expression to determine if an error occurred:

0.4196 sin(0.57717πh)≦|Z(N)|≦0.4196 sin(πh).

In some implementations of an apparatus, processor, or method, the plurality of modulated bits are modulated using Differential Phase-Shift Keying (DPSK) modulation and the process is further configured to use a demodulation metric W(N) as illustrated in the following expression to determine if an error occurred:

W(N)=0.3597e^{ja(N)}(1−0.65^{N})≦0.3597e^{ja(N)}.

Another innovation includes an apparatus for detecting demodulation bit errors in a plurality of modulated bits includes a memory configured to store a first threshold and a second threshold, and a processor coupled to the memory, the processor configured to retrieve the first threshold and second threshold from the memory and determine a demodulation metric value for each of the plurality of modulated bits, the processor further configured to, for demodulation metric values that cross the first threshold, calculate a measure representing how much each demodulation metric value exceeds the first threshold, sum the calculated measures, and compare the sum of the calculated measures to the second threshold.

Another innovation includes a method of detecting demodulation bit errors in a plurality of modulated bits the method including storing a first threshold and a second threshold in memory, retrieving the first threshold and the second threshold from the memory, determining a demodulation metric value for each of the plurality of modulated bits, counting the number of demodulation metric values that cross the first threshold, and comparing the second threshold to the number of demodulation metric values that cross the first threshold.

Another innovation includes a method for detecting demodulation bit errors of a plurality of modulated bits. In some implementations, the method includes storing a first threshold and a second threshold, and retrieving the first threshold and second threshold from the memory, determining a demodulation metric value for each of the plurality of modulated bits, for each of the demodulation metric values that cross the first threshold, calculating a measure representing how much each demodulation metric value exceeds the first threshold, summing the calculated measures of how much each demodulation metric value exceeds the first threshold, and comparing the sum of the calculated measures to the second threshold.

Another innovation includes a computer readable medium comprising instructions that, when executed, cause an apparatus to perform a method for detecting demodulation bit errors of a plurality of modulated bits. In some implementations the method for detecting demodulation errors includes storing a first threshold and a second threshold in memory, and retrieving the first threshold and the second threshold from the memory, determining a demodulation metric value for each of the plurality of modulated bits, counting the number of demodulation metric values that cross the first threshold, and comparing the second threshold to the number of demodulation metric values that cross the first threshold.

Another innovation includes computer readable medium comprising instructions that, when executed, cause an apparatus to perform a method for detecting demodulation bit errors of a plurality of modulated bits, the method including storing a first threshold and a second threshold, retrieving the first threshold and second threshold from the memory, determining a demodulation metric value for each of the plurality of modulated bits, for each of the demodulation metric values that cross the first threshold, calculating a measure representing how much each demodulation metric value exceeds the first threshold, summing the calculated measures of how much each demodulation metric value exceeds the first threshold; and comparing the sum of the calculated measures to the second threshold.

Another innovation includes an apparatus for detecting demodulation bit errors of a plurality of modulated bits, the apparatus including means for storing a first threshold and a second threshold, means for processing coupled to the storing means, the processing means configured to retrieve the first threshold and second threshold from the storing means and to determine a demodulation metric value for each of the plurality of modulated bits, the processing means further configured to count the number of demodulation metric values that cross the first threshold and compare the second threshold to the number of demodulation metric values that cross the first threshold.

Another innovation includes an apparatus for detecting demodulation bit errors of a plurality of modulated bits, the apparatus including a means for storing a first threshold and a second threshold, and a means for processing coupled to the storing means, the processing means configured to retrieve the first threshold and second threshold from the storing means and determine a demodulation metric value for each of the plurality of modulated bits, the storing means further configured to, for demodulation metric values that cross the first threshold, calculate a measure representing how much each demodulation metric value exceeds the first threshold, sum the calculated measures, and compare the sum of the calculated measures to the second threshold.

### BRIEF DESCRIPTION OF THE DRAWINGS

FIG. 1 illustrates a schematic of some exemplary communication devices that may be configured for Bluetooth communication and implement the methods and systems to detect the occurrence of erroneous demodulated bits.

FIG. 2 illustrates an example of a functional block diagram of a wireless communication device that can be configured to implement transmitter and/or receiver sequence-based testing.

FIG. 3A illustrates one configuration for detecting the occurrence of erroneous demodulated bits.

FIG. 3B is a schematic illustrating an example of a system configured for detecting the occurrence of erroneous demodulated bits.

FIG. 4 is a graphical depiction of simulation results of Gaussian Frequency-Shift Keying (GFSK) demodulation metric values versus a theoretical bound in Expression (14), in particular, for Z(n) at Signal-to-Noise (SNR) equal to 33 dB.

FIG. 5 is a graphical depiction of simulation and theoretical results of Differential Phase-Shift Keying (DPSK) demodulation metric values for W(N) in Expression (22), in particular, depicting W(n) for Differential Quaternary Phase-Shift Keying (DQPSK) at SNR equal to 33 dB.

FIG. 6 is a graphical depiction of simulation and theoretical results of Differentially Encoded 8-Phase Shift Keying (D8PSK) demodulation metric values for W(N) in Expression (22), in particular, depicting W(n) for (D8PSK) at SNR equal to 33 dB.

FIG. 7 is a graphical depiction of simulation and theoretical results of Differentially Encoded 8-Phase Shift Keying (D8PSK) demodulation metric values for W(N) in Expression (22) rotated by π/8, in particular, depicting W(n) for D8PSK at SNR equal to 33 dB illustrated in FIG. 6 rotated by π/8.

FIG. 8 is a graphical depiction of simulation and theoretical results of Differentially Encoded 8-Phase Shift Keying (D8PSK) demodulation metric values for W(N) in Expression (22) rotated by −π/8, in particular, depicting W(n) for (D8PSK) at SNR equal to 33 dB illustrated in FIG. 6 rotated by −π/8.

FIG. 9 is a schematic illustrating one example of a packet of information communicated via a wireless communication system.

FIG. 10 is a flowchart that illustrates an example of a process for detecting the occurrence of erroneous demodulated bits.

FIG. 11 is a flowchart that illustrates another example of a process for detecting the occurrence of erroneous demodulated bits.

FIG. 12 illustrates a block diagram of an apparatus for detecting demodulated bit errors of a plurality of modulated bits.

### DETAILED DESCRIPTION OF CERTAIN EMBODIMENTS

The following detailed description is directed to certain specific embodiments of the invention. However, the invention can be embodied in a multitude of different ways. The aspects herein may be embodied in a wide variety of forms and any specific structure, function, or both being disclosed herein is merely representative. An aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

The systems and methods described herein are described with respect to Bluetooth wireless technologies. The systems and methods may be particularly relevant to portions of the Bluetooth V4.0 standard. However, the systems and methods may also be relevant to other similar wireless technologies including other versions of the Bluetooth standard. Certain details about the Bluetooth standard may be found in Bluetooth Specification Version 4.0, published Jun. 30, 2010.

Further, the systems and methods described herein may be implemented on a variety of different computing devices. These include general purpose or special purpose computing system environments or configurations. Examples of computing systems, environments, and/or configurations that may be suitable for use with the configurations described herein include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like. Further, the systems and methods may be implemented in mobile devices (e.g., phones, smartphones, Personal Digital Assistants (PDAs), Ultra-Mobile Personal Computers (UMPCs), Mobile Internet Devices (MIDs), etc.).

Disclosed are certain examples of physical layer (PHY) error detection methods and systems for a Bluetooth (BT) modem. Such methods and systems may also apply to other wireless communication systems. A physical layer error detector detects the occurrence of erroneous demodulated bits in the payload. The need of the physical layer error detector is based on that, when the payload of a communicated packet is heavily corrupted, there may be a lot of erroneous demodulated bits in the payload but a 16-bit CRC, currently used in Bluetooth communications, may falsely pass such data. That is, a Bluetooth receiver may falsely identify erroneous data as good data and accordingly it will not flag such data for re-transmission. This may occur when erroneous data is in a payload of such a large size that it exceeds the capability of a 16 bit CRC to identify errors in the payload. In some implementations, when the PHY error detector is enabled, it is assumed that it will be enabled when a demodulator is starting to demodulate the payload.

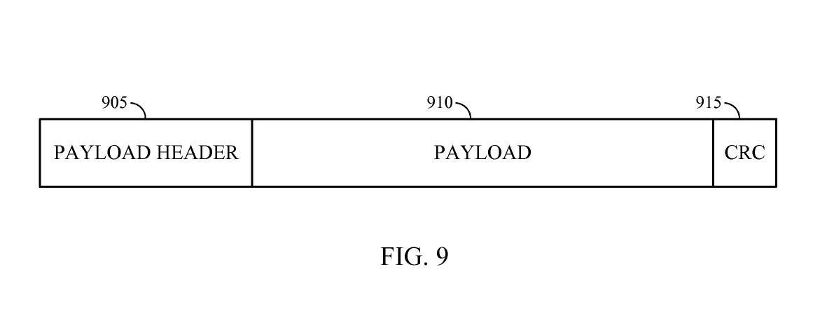

An erroneous payload header may cause more damage to the system than erroneous data in a payload. To more accurately determine if a payload header is erroneous in some implementations an error detector can place more weight on the payload header than on the payload itself when evaluating a packet for erroneous data. This is further described in reference to FIG. 9 below.

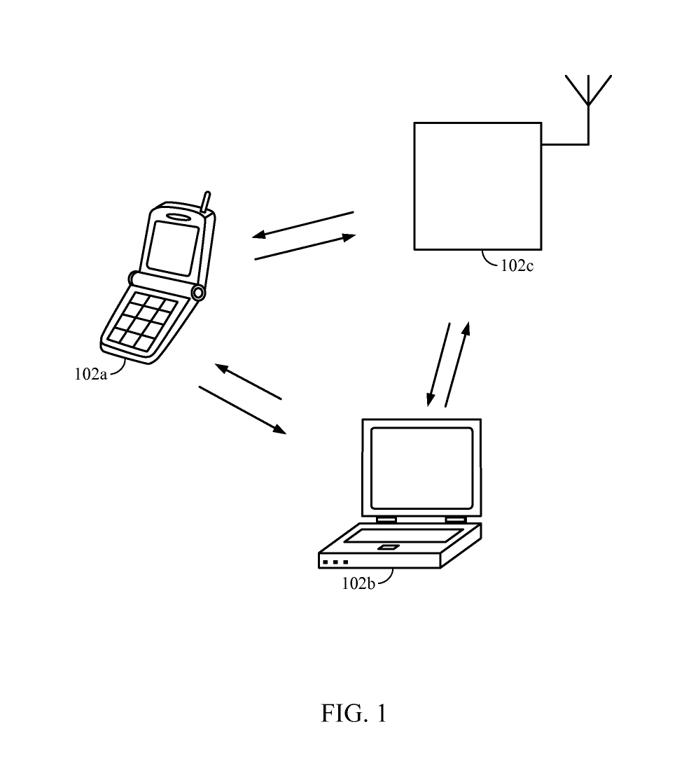

FIG. 1 illustrates a schematic of some exemplary wireless communication devices that may be configured for Bluetooth communication and implement the methods and systems described herein to detect the occurrence of erroneous demodulated bits. Such devices can include any type of communication device. FIG. 1 illustrates such devices, which may include, but are not limited to, a cell phone 102a, a laptop computer 102b and a device 102c, all being configured for Bluetooth communication, and typically configured for other wireless and/or wired communication modes, for example, Wi-Fi or cellular. The device 102c represents any type of computing device that can be configured for wireless communication, including, but not limited, to any type of computer, a server, a portable hard drive, a PDA or other mobile computing device, a computer game, a pointing device including a mouse, a pen, a trackball, a joystick or any other type of controller, an appliance, a television, and an audio or video device including a CD player or a DVD player.

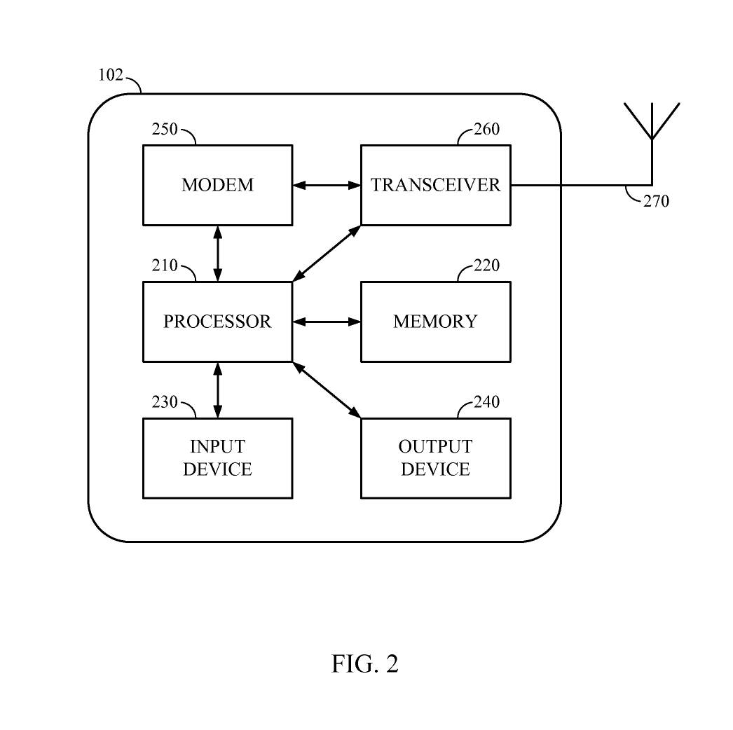

FIG. 2 is a functional block diagram of a wireless communication device 102. Wireless communication device 102 may be representative of one of the devices 102a-c described in reference to FIG. 1. The wireless communication device 102 includes a processor 210 in data communication with a memory 220, an input device 230, and an output device 240. The processor is further in data communication with a modem 250 and a transceiver 260. The transceiver 260 is also in data communication with the modem 250 and an antenna 270. Although described separately, it is to be appreciated that functional blocks described with respect to the wireless communication device 102 need not be separate structural elements. For example, the processor 210 and memory 220 may be embodied in a single chip. Similarly, two or more of the processor 210, modem 250, and transceiver 260 may be embodied in a single chip.

The processor 210 can be a general purpose processor, a digital signal processor (DSP), an application specific integrated circuit (ASIC), a field programmable gate array (FPGA) or other programmable logic device, discrete gate or transistor logic, discrete hardware components, or any suitable combination thereof designed to perform the functions described herein. A processor may also be implemented as a combination of computing devices, e.g., a combination of a DSP and a microprocessor, a plurality of microprocessors, one or more microprocessors in conjunction with a DSP core, or any other such configuration.

The processor 210 can be coupled, via one or more buses, to read information from or write information to memory 220 (sometimes referred to as a “memory unit,” a “memory component” or simply “memory”). The processor may additionally, or in the alternative, contain memory (for example, processor registers). The memory 220 can include a processor cache, including a multi-level hierarchical cache in which different levels have different capacities and access speeds. The memory 220 can also include random access memory (RAM), other volatile storage devices, or non-volatile storage devices. The storage can include hard drives, optical discs, such as compact discs (CDs) or digital video discs (DVDs), flash memory, floppy discs, magnetic tape, and Zip drives. The memory can store information that is used for erroneous demodulated bit detection, including threshold values or information that is used in calculating demodulated bit values.

The processor 210 may also be coupled to an input device 230 and an output device 240 for, respectively, receiving input from and providing output to, a user of the wireless communication device 102. Suitable input devices include, but are not limited to, a keyboard, buttons, keys, switches, a pointing device, a mouse, a joystick, a remote control, an infrared detector, a video camera (possibly coupled with video processing software to, e.g., detect hand gestures or facial gestures), a motion detector, or a microphone (possibly coupled to audio processing software to, for example, detect voice commands). Suitable output devices include, but are not limited to, visual output devices, including displays and printers, audio output devices, including speakers, headphones, earphones, and alarms, and haptic output devices, including force-feedback game controllers and vibrating devices.

The processor 210 is further coupled to a modem 250 and a transceiver 260. The modem 250 and transceiver 260 prepare data generated by the processor 210 for wireless transmission via the antenna 270 according to one or more air interface standards (for example, Bluetooth). The modem 250 and transceiver 260 also demodulate data received via the antenna 270 according to one or more air interface standards. The transceiver can include a transmitter, receiver, or both. In other embodiments, the transmitter and receiver are two separate components. The modem 250 and transceiver 260, can be embodied as a general purpose processor, a digital signal processor (DSP), an application specific integrated circuit (ASIC), a field programmable gate array (FPGA) or other programmable logic device, discrete gate or transistor logic, discrete hardware components, or any suitable combination thereof designed to perform the functions described herein.

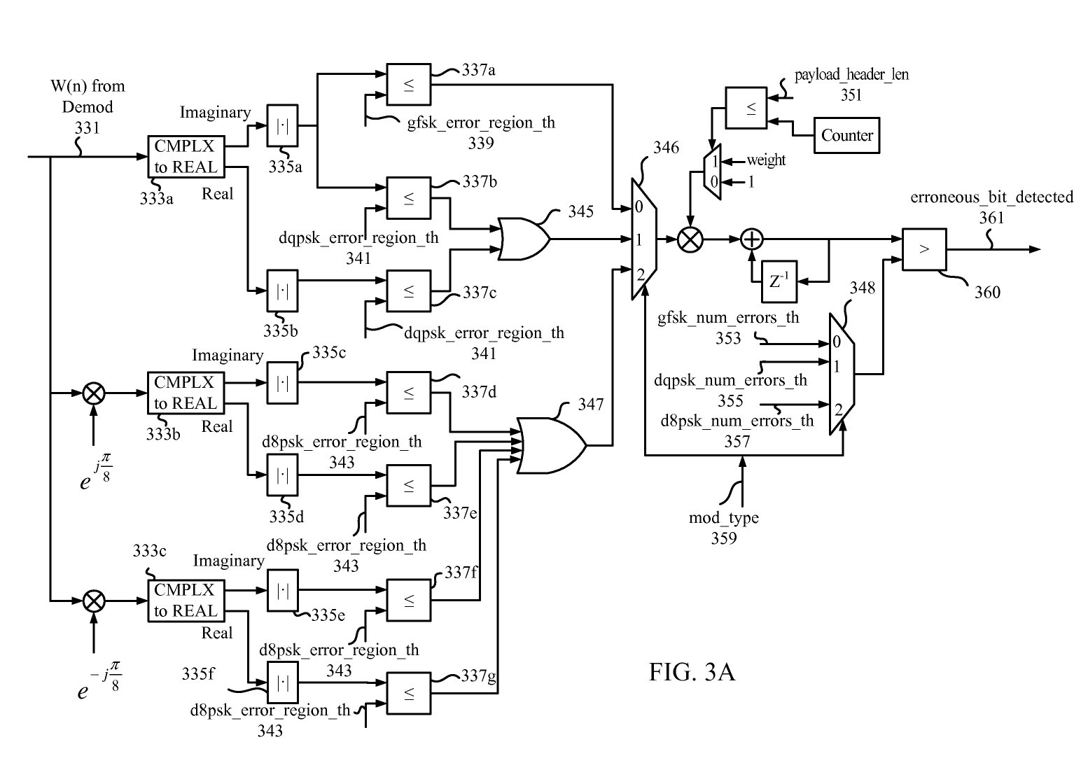

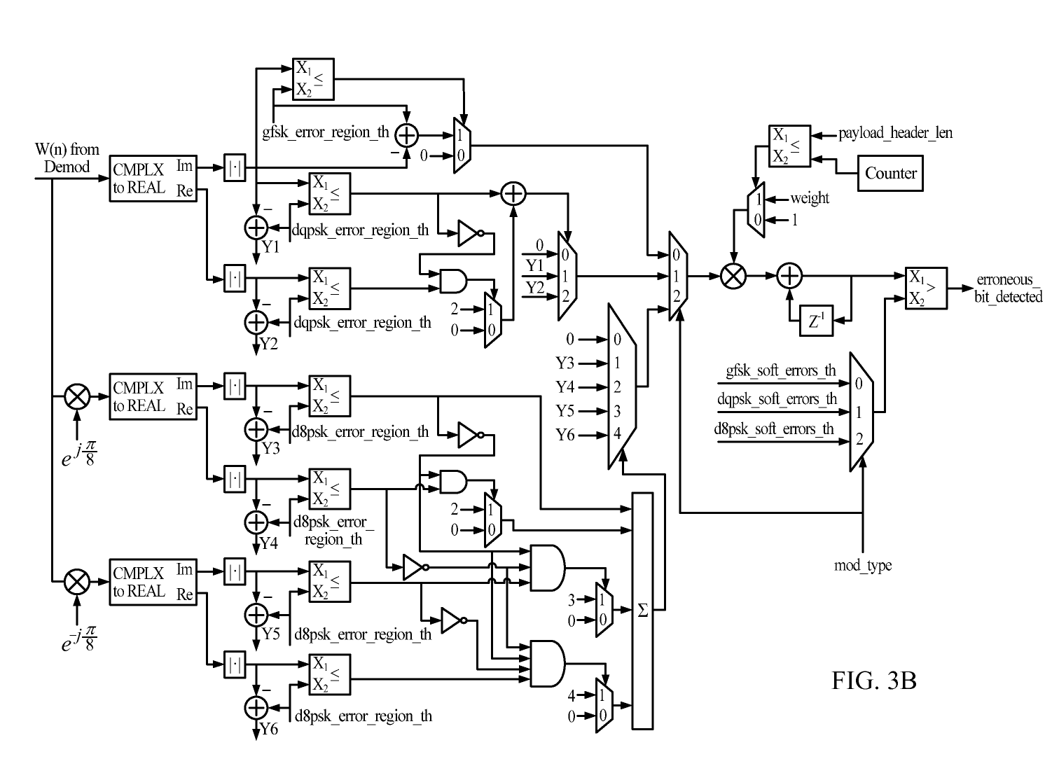

FIG. 3A illustrates one configuration for detecting the occurrence of erroneous demodulated bits. A matrix W(n) 331 is received from the demodulator. Multiple paths are illustrated, depending on whether GFSK modulation is used, DQPSK modulation is used or DQPSK modulation is used.

For the GFSK modulation, the matrix W(n) 331 is separated into an imaginary component and a real component by a complex-to-real converter 333a. The absolute value of the imaginary component is computed by the box 335a. Once the absolute value has been computed 335a, the imaginary component may then be compared with a GFSK error threshold gfsk_error_region_th 339 by a comparator 337a. If the imaginary component is less than or equal to the GFSK error threshold gfsk_error_region_th 339, the comparator 337a may output a 1 (digital high). If the imaginary component is greater than the GFSK error threshold gfsk_error_region_th 339, the comparator 337a may output a 0 (digital low). The output of the comparator 337a is then provided to a first input of a first multiplexer 346.

For the DQPSK modulation, both the real component and the imaginary component of the matrix W(n) 331 may be used. After the absolute value of the imaginary component has been computed by the box 335a, the imaginary component may be compared with the DQPSK error threshold dqpsk_error_region_th 341 by a comparator 337b. If the imaginary component is less than or equal to the DQPSK error threshold dqpsk_error_region_th 341, the comparator 337b may output a 1. If the imaginary component is greater than the DQPSK error threshold dqpsk_error_region_th 341, the comparator 337b may output a 0.

The absolute value of the real component may also be computed by the box 335b. After the absolute value of the real component has been computed by the box 335b, the real component may be compared with the DQPSK error threshold dqpsk_error_region_th 341 by a comparator 337c. If the real component is less than or equal to the DQPSK error threshold dqpsk_error_region_th 341, the comparator 337c may output a 1. If the real component is greater than the DQPSK error threshold dqpsk_error_region_th 341, the comparator 337c may output a 0. The output of the comparator 337b and the output of the comparator 337c may then each be input to an OR gate 345. The output of the OR gate may be provided to a second input of the first multiplexer 346.

For D8PSK modulation, the signal W(n) 331 may need to be rotated for error detection. The signal W(n) 331 may be rotated in a first rotation by

$${e}^{j \frac{π}{8}}$$

and in a second rotation by

$${e}^{- j \frac{π}{8}} .$$

After the first rotation, the signal W(n) 331 may be separated into a real component and an imaginary component (by the complex-to-real converter 333b). The absolute value of the imaginary component may be computed by the box 335c and then the imaginary component may be compared with the D8PSK error threshold d8psk_error_region_th 343 using the comparator 337d. If the imaginary component is less than or equal to the D8PSK error threshold d8psk_error_region_th 343, the comparator 337d may output a 1. If the imaginary component is greater than the D8PSK error threshold d8psk_error_region_th 343, the comparator 337d may output a 0. The output of the comparator 337d may be provided to an OR gate 347.

The absolute value of the real component may be computed by the box 335d and then the real component may be compared with the D8PSK error threshold d8psk_error_region_th 343 using the comparator 337e. If the real component is less than or equal to the D8PSK error threshold d8psk_error_region_th 343, the comparator 337e may output a 1. If the real component is greater than the D8PSK error threshold d8psk_error_region_th 343, the comparator 337e may output a 0. The output of the comparator 337e may be provided to the OR gate 347.

After the second rotation, the signal W(n) 331 may be separated into a real component and an imaginary component (by the complex-to-real converter 333c). The absolute value of the imaginary component may be computed by the box 335e and then the imaginary component may be compared 337f with the D8PSK error threshold d8psk_error_region_th 343 by a comparator 337f. If the imaginary component is less than or equal to the D8PSK error threshold d8psk_error_region_th 343, the comparator 337f may output a 1. If the imaginary component is greater than the D8PSK error threshold d8psk_error_region_th 343, the comparator 337f may output a 0. The output of the comparator 337f may be provided to the OR gate 347.

The absolute value of the real component may be computed by the box 335f and then the real component may be compared with the D8PSK error threshold d8psk_error_region_th 343 by a comparator 337g. If the real component is less than or equal to the D8PSK error threshold d8psk_error_region_th 343, the comparator 337g may output a 1. If the real component is greater than the D8PSK error threshold d8psk_error_region_th 343, the comparator 337g may output a 0. The output of the comparator 337g may be provided to the OR gate 347. The output of the OR gate 347 may be provided to a third input of the first multiplexer 346.

The second multiplexer 348 may receive a GFSK number of errors threshold gfsk_num_errors_th 353 in a first input, a DQPSK number of errors threshold DQPSK number of errors threshold dqpsk_num_errors_th 355 in a second input and a D8PSK number of errors threshold d8psk_num_errors_th 357 in a third input.

The first multiplexer 346 and the second multiplexer 348 may be controlled by a mod_type signal 359 that indicates the type of modulation being used. If the mod_type signal 359 indicates that GFSK modulation is used, the first multiplexer 346 and the second multiplexer 348 pass the first inputs (the 0 input). If the mod_type signal 359 indicates that DQPSK modulation is used, the first multiplexer 346 and the second multiplexer 348 pass the second inputs (the 1 input). If the mod_type signal 359 indicates that D8PSK modulation is used, the first multiplexer 346 and the second multiplexer 348 pass the third inputs (the 2 input).

Weighting may be used based on the payload header length payload_header_len 351. As described below, the header provides more important information than the payload and thus is weighted higher. The payload header length payload_header_len 351 may be compared with a counter. If the payload header length is greater than or equal to the counter, then a multiplexer passes a weight. If the payload header length is less than the counter, then a multiplexer passes a 1 (meaning no additional weighting is provided). The output of the multiplexer may be multiplied with the output of the first multiplexer. Using feedback, the output of the multiplier may be added to previous outputs to obtain a total error.

The total error may be compared with the total error threshold passed by the second multiplexer 348 (as indicated by the mod_type 359) using the comparator 360. Thus, for GFSK modulation, the total error may be compared with the GFSK number of errors threshold gfsk_num_errors_th 353. For DQPSK modulation, the total error may be compared with the DQPSK number of errors threshold dqpsk_num_errors_th 355. For D8PSK modulation, the total error may be compared with the D8PSK number of errors threshold d8psk_num_errors_th 357. If the total error is greater than the number of errors threshold, then the comparator 360 will output that an erroneous bit is detected in the erroneous_bit_detected 361 signal (i.e., a digital one). If the total error is less than or equal to the number of errors threshold, then the comparator 360 will output that no erroneous bit was detected in the erroneous_bit_detected 361 signal (i.e., a digital zero).

FIG. 3B is a schematic illustrating an example implementation of a circuit configured for detecting the occurrence of erroneous demodulated bits in a communication system, for example, for Bluetooth (BT) communications, and that may be included in a device, for example, device 102a-c illustrated in FIG. 1. Other circuit implementations are also possible to perform the functionality of the circuit illustrated in FIG. 3B. As illustrated in FIG. 3B, the circuit is configured to receive a signal input W(n) from a demodulator. The circuit is configured to route and process a signal, calculating an error metric for Gaussian Frequency-Shift Keying, Differential Quaternary Phase-Shift Keying, or Differentially Encoded 8-Phase Shift Keying modulated bits. In doing so, the illustrated circuit is configured to receive a parameter that is used to set the region where the demodulator's decision metric falling in will be used to calculate the error metric. For example, parameters gfsk_error_region_th, dqpsk_error_region_th, and d8psk_error_region_th (see Table 1) may be inputs to the circuit. Such a circuit may also be configured to use a threshold (for GFSK, DQPSK, or D8PSK modulated bits) above which an erroneous bit is detected. In this illustrative implementation, the circuit can use threshold inputs referred to in FIG. 3B as gfsk_error_th, dqpsk_error_th, and d8psk_error_th (see descriptions of these signals listed in Table 1). The circuit may be further configured to receive a header payload duration parameter (for example, pl_header_length), which is used to select the duration of a beginning portion of the payload that we want to put more weight. The circuit is further configured to receive a header weight (e.g., pl_header_weight) that is used to set the weight that is applied to modulated bits in the header as their accuracy may be deemed to be more important.

Table 1 (below) illustrates examples of programmable parameters for an implementation of a physical layer error detector for detecting the occurrence of erroneous demodulated bits in error detection systems, circuits or processors. For example, the programmable parameters may be used in the example implementation of an error detection circuit illustrated in FIG. 3B.

TABLE 1
Examples of Programmable Parameters for PHY error detector

| Signal name | Description |
|---|---|
| gfsk_error_region_th | GFSK error region threshold: This parameter |
| | is used to set a region where, if the GFSK |
| | demodulator's decision metric falls in the |
| | region, the GFSK demodulator's decision |
| | metric will be used to calculate the error |
| | metric for GFSK. |
| dqpsk_error_region_th | DQPSK error region threshold: This |
| | parameter is used to set a region where, if the |
| | DQPSK demodulator's decision metric falls |
| | in the region, the DQPSK demodulator's |
| | decision metric will be used to calculate the |
| | error metric for DQPSK. |
| d8psk_error_region_th | D8PSK error region threshold: This parameter |
| | is used to set a region where, if the D8PSK |
| | demodulator's decision metric falls in the |
| | region, the D8PSK demodulator's decision |
| | metric will be used to calculate the error |
| | metric for D8PSK. |
| gfsk_error_th | GFSK error threshold: If the error metric for |
| | GFSK is greater than the GFSK error |
| | threshold, an erroneous_bit_detected is |
| | asserted. |
| dqpsk_error_th | DQPSK error threshold: If the error metric for |
| | DQPSK is greater than the DQPSK error |
| | threshold, an erroneous_bit_detected is |
| | asserted. |
| d8psk_error_th | D8PSK error threshold: If the error metric for |
| | D8PSK is greater than the D8PSK threshold, |
| | an erroneous_bit_detected is asserted. |
| pl_header_length | Payload header length: This parameter is used |
| | to select the duration of a beginning portion |
| | of the header payload where more weight will |
| | be put for calculating the presence of |
| | erroneous bits. (0: 8 μs; 1: 16 μs; 2: 24 μs; |
| | 3: 32 μs) |
| pl_header_weight | Payload header weight: This parameter is |
| | used to set the weight that is applied to the |
| | bits indicated by the pl_header_length. |

Certain details of processes for erroneous demodulated bit detection is described below, one illustrative example being for Gaussian Frequency-Shift Keying demodulation, and another illustrative example being for Differential Phase-Shift Keying demodulation. As a person of ordinary skill in the art will appreciate, these illustrative examples of certain innovations described herein are not meant to limit the innovation, rather they present certain technical details for enabling a person of ordinary skill in the art to practice the innovations.

### Erroneous Demodulated Bit Detection for GFSK Demodulation

The decision metric based on maximum likelihood (ML) criterion for Gaussian Frequency-Shift Keying decision feedback demodulation is

$$\begin{matrix}{\hat{X}}_{i} ( N ) = 2 Re \{ M * ( N - 1 ) r ( N ) {e}^{- jπ {hI}_{i} ( N - 2 )} \} \\ where & ( 1 ) \\ \begin{matrix}M ( N - 1 ) = M ( N - 2 ) {e}^{- jπ hd ( N - 3 )} + r ( N - 1 ) \\ = {\sum }_{n = 1}^{N - 1} r ( n ) {e}^{jπ h {\sum }_{k = n - 1}^{N - 3} d ( k )}\end{matrix} & ( 2 )\end{matrix}$$

d(k) being the demodulated bit at the receiver, if there is no error d(k)=I(k) (the transmitted information bit),
and

r(N)=s(N)+\tilde{n}(N) (3)
r(N) the signal received at a receiver, s(N) the transmitted signal portion of the received signal, \check{n}(N) the noise of the received signal,
where

$$\begin{matrix}s ( N ) = {e}^{j ( 2 π h {\sum }_{k = N - 2}^{N} I ( k ) q ( NT - kT ) + π h {\sum }_{k = 0}^{N - 3} I ( k ) + {φ}_{0} )} \\ = {e}^{j ( 2 π hq ( T ) ( I ( N - 1 ) - I ( N - 2 ) ) + π h {\sum }_{k = 0}^{N - 2} I ( k ) + {φ}_{0} )}\end{matrix} \qquad ( 4 )$$

where q(NT−kT) is the q-function, and h is the modulation index.

Expression (4) is based on the assumption, for an example implementation, that a transmitter uses a Gaussian filter with a length of three symbols. Special cases of s(N) in Expression (4) are shown in Expression (5).

$$\{ \begin{matrix}s ( 0 ) = {e}^{j ( {φ}_{0} )} \\ s ( 1 ) = {e}^{j ( 2 π hI ( 0 ) q ( T ) + {φ}_{0} )} \\ s ( 2 ) = {e}^{j ( 2 π h ( I ( 0 ) q ( 2 T ) + I ( 1 ) q ( T ) ) + {φ}_{0} )}\end{matrix} \qquad ( 5 )$$

The detection of Iᵢ(N−2), namely d(N−2)=sign[Im{M*(N−1)r(N)}].

For certain practical implementations, to avoid the M(N) in Expression (2) from being incalculable or impractical to calculate, decision feedback modulation (DFD) may be implemented as follows:

M(N)=α×M(N−1)e^{jπhd(n-2)}+r(N);d(N−2)=sign[Im{M*(N−1)r(N)}] (6)

where α is the forgetting factor and 0≦α<1.

Some implementations may have a digital variable gain amplifier (DVGA), and input to the decision feedback demodulation (DFD) is after the DVGA, thus r(N) becomes

$$\begin{matrix}r ( N ) = \tilde{s} ( N ) + {\tilde{n}}_{2} ( N ) \\ where & ( 7 ) \\ \begin{matrix}\tilde{s} ( N ) = A {e}^{j ( 2 π h {\sum }_{k = N - 2}^{N} I ( k ) q ( NT - kT ) + π h {\sum }_{k = 0}^{N - 3} I ( k ) + {φ}_{0} )} \\ = A {e}^{j ( 2 π hq ( T ) ( I ( N - 1 ) - I ( N - 2 ) ) + π h {\sum }_{k = 0}^{N - 2} I ( k ) + {φ}_{0} )} .\end{matrix} & ( 8 )\end{matrix}$$

In one example, based on a digital variable gain amplifier controlling, A=0.3548, which provides totally 9 dB headroom. In addition, the receiver may not know what the transmitted modulation index is, so the receiver uses its estimated modulation index for the decision feedback demodulation. Thus, metric M(N−1) in Expression (2) becomes

$$\begin{matrix}M ( N - 1 ) = α M ( N - 2 ) {e}^{jπ \hat{h} d ( N - 3 )} + r ( N - 1 ) \\ = {\sum }_{n = 1}^{N - 1} {α}^{N - 1 - n} r ( n ) {e}^{jπ \hat{ h} {\sum }_{k = n - 1}^{N - 3} d ( k )} ,\end{matrix} \\ with {\sum }_{k = N - 2}^{N - 3} d ( k ) = 0 \qquad ( 9 )$$

In some implementations, W(N)=M⁸(N)r(N+1). In the noiseless condition and if \check{h}=h and d(k)=I(k), W(N) can be shown as

$$\begin{matrix}W ( N ) = {\sum }_{n = 1}^{N} {α}^{N - n} \tilde{s} ( N + 1 ) {\tilde{s}}^{*} ( n ) {e}^{- jπ h {\sum }_{k = n - 1}^{N - 2} I ( k )} \\ = {\sum }_{n = 1}^{N} {α}^{N - n} {A}^{2} {e}^{j ( Δφ ( N + 1 ) + π h {\sum }_{k = 0}^{N - 1} I ( k ) + {φ}_{0} )} {e}^{- j ( Δφ ( n ) + π h {\sum }_{k = 0}^{n - 2} I ( k ) + {φ}_{0} + π h {\sum }_{k = n - 1}^{N - 2} I ( k ) )} \\ = {A}^{2} {\sum }_{n = 1}^{N} {α}^{N - n} {e}^{j ( Δφ ( N + 1 ) - Δφ ( n ) + π h {\sum }_{k = 0}^{N - 1} I ( k ) - π h {\sum }_{k = 0}^{n - 2} I ( k ) - π h {\sum }_{k = n - 1}^{N - 2} I ( k ) )} \\ = {A}^{2} {\sum }_{n = 1}^{N} {α}^{N - n} {e}^{j ( Δφ ( N + 1 ) - Δφ ( n ) + π hI ( N - 1 ) )}\end{matrix} \qquad ( 10 )$$

where Δφ(n)=2πq(T)[I(n−1)−I(n−2)]. Now W(N) can be re-written as:

$$\begin{matrix}W ( N ) = {A}^{2} {\sum }_{n = 1}^{N} {α}^{N - n} {e}^{j ( 2 π hq ( T ) [ I ( N ) - I ( N - 1 ) - I ( n - 1 ) + I ( n - 2 ) ] + π hI ( N - 1 ) )} \\ = {A}^{2} {\sum }_{n = 1}^{N} {α}^{N - n} {e}^{j ( 2 π hq ( T ) [ I ( N ) - I ( n - 1 ) + I ( n - 2 ) ] + 2 π hq ( 2 T ) I ( N - 1 ) )}\end{matrix} \qquad ( 11 )$$

Given that q(T)=0.0528571 and q(2T)=0.4471429, and let Z(N) denote the final metric that is used to demodulate the N^{th} bit, i.e. Z(N)=Im{W(N)}. Z(N) is expressed as follows

$$Z ( N ) = {A}^{2} {\sum }_{n = 1}^{N} {α}^{N - n} sin ( 0.1057 π h [ I ( N ) - I ( n - 1 ) + I ( n - 2 ) ] + 0.8943 π hI ( N - 1 ) ) \qquad ( 12 )$$

Since 0.28≦h≦0.35 and α<1, applying the geometric series to Expression (12) it can be shown that

$${A}^{2} \frac{sin ( 0.5771 π h )}{1 - α} \leq \vert Z ( N ) \vert \leq {A}^{2} \frac{sin ( π h )}{1 - α} \qquad ( 13 )$$

And I(N−1) determines the polarity of Z(N), hence the demodulation of I(N−1), namely d(N−1)=sign[Z(N)] as shown in Expression (6). If α is set to 0.7 for Gaussian Frequency-Shift Keying decision feedback demodulation, Expression (13) becomes

0.4196 sin(0.57712πh)≦|Z(N)|≦0.4196 sin(πh) (14)

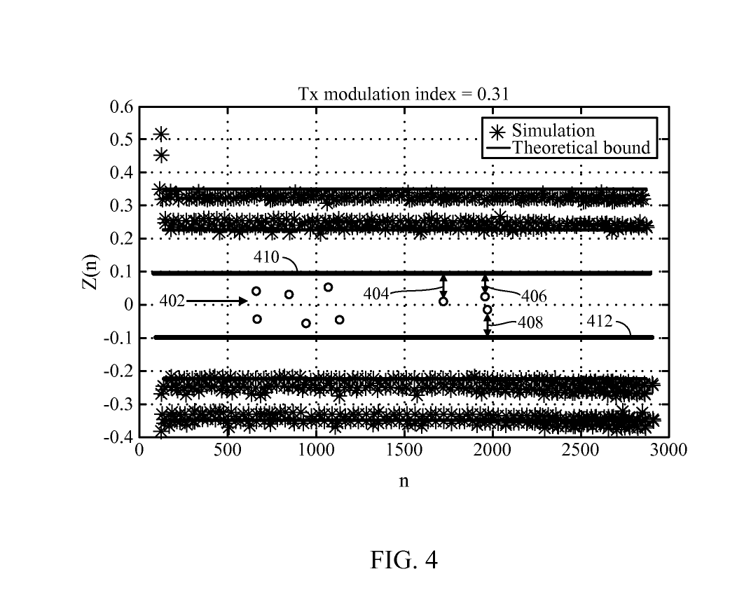

Z(n) may be referred to as the demodulation metric. That is, FIG. 4 is a graphical depiction of simulation results of Gaussian Frequency-Shift Keying demodulation versus a theoretical bound in Expression (14), in particular, for Z(n) at Signal-to-Noise (SNR) equal to 33 dB. The variation of Z(n) gets larger as SNR decreasing and the DFD makes wrong decision when I(n−1) and Z(n) have opposite polarity. As depicted in FIG. 4, the demodulation metric values generally fall into two groups of data, one group above the decision boundary Z(n)=0 and one group below the decision boundary Z(n)=0. In one implementation for an erroneous bit detector, a first threshold is established. As illustrated in FIG. 4, for the group of Z(n) data below the“0”, a (first) threshold 412 is depicted. For the group of data above “0”, a (first) threshold 410 is depicted. In one implementation, to determine if the demodulated bit values are erroneous, the number of demodulation metric values 402 that exceed the first threshold values are counted. In the example illustrated in FIG. 4, there are six demodulation values 402 that exceed the thresholds: three demodulation metric values 402 that exceed the threshold 412, these values graphically illustrated as being positioned between the threshold 412 and the decision boundary Z(n)=0, and three demodulation metric values 402 that exceed threshold 410, illustrated as being between the threshold 410 and the decision boundary Z(n)=0. This count of demodulation metric values exceeding the first threshold may be compared to a second threshold (for example, a count threshold) and if the count is higher than the second threshold, the demodulated bits may be deemed to include erroneous demodulated bits. An example of an implementation of a process to detect erroneous demodulated bits for Gaussian Frequency-Shift Keying can be shown by the following pseudo code:

```
numErrorCounter = 0;
ErroneousBitDetected = false;
while (!endOfPacket)
{
  if (abs(Z(n)) <= GFSKErrorRegionThreshold)
  {
    numErrorCounter++;
  }
  ErroneousBitDetected = (numErrorCounter > GFSKNumErrorThreshold);
}
```

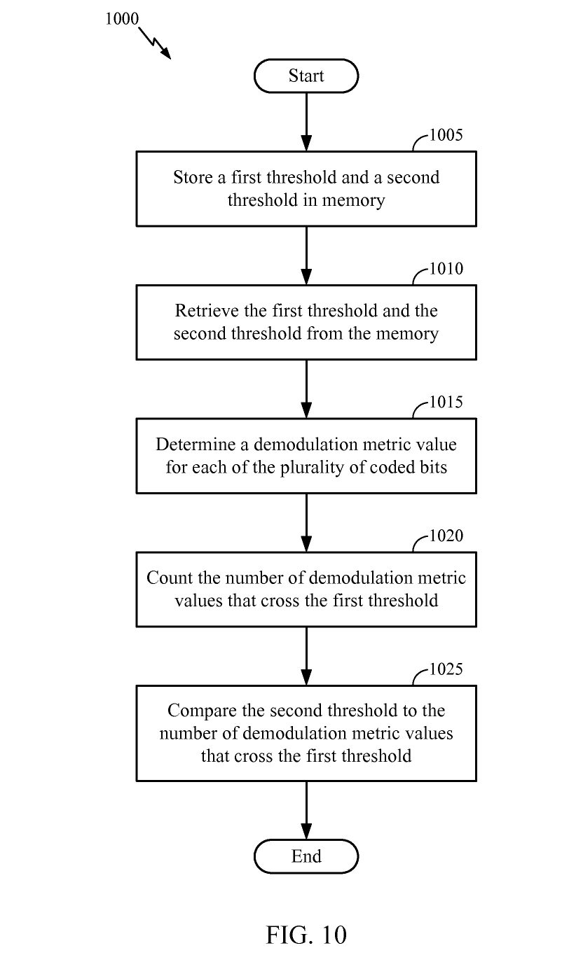

A process for detecting erroneous demodulated bits using a counting implementation is further described in reference to FIG. 10.

In another implementation of detecting erroneous demodulated bits, demodulation metric values that exceed the first threshold are determined, and the distance by which each demodulation metric value exceeds the first threshold is measured (or determined). For example, FIG. 4 illustrates an example of three demodulation metric values 404, 406 and 408 that exceed one of the thresholds 410 or 412. The demodulation metric values 404 and 406 exceed threshold 410 each by a distance as illustrated by the double-arrow, and the demodulation metric value 408 exceeds threshold 412 by a distance illustrated by the double-arrow. The measurement for each of the demodulation metric values 404, 406 and 408 that exceed a threshold are added together, and then compared to a second threshold. If the sum of the measurements exceeds the second threshold, the demodulated bits may be deemed to include erroneous demodulated bits. This method of detection may be referred as detection using a “soft metric” because it is based on a measurement of how much each demodulation metric vale exceeds the calculated threshold for Z(n), not just the number of demodulation metric values that exceed the threshold. An example of an implementation of a process to detect erroneous demodulated bits for Gaussian Frequency-Shift Keying is be shown by the following pseudo code:

```
softErrorMetric = 0;
ErroneousBitDetected = false;
while (!endOfPacket)
{
  if (abs(Z(n)) <= GFSKErrorRegionThreshold)
  {
    softErrorMetric += (GFSKErrorRegionThreshold − abs(Z(n)));
  }
  ErroneousBitDetected = (softErrorMetric > GFSKSoftErrorThreshold);
}
```

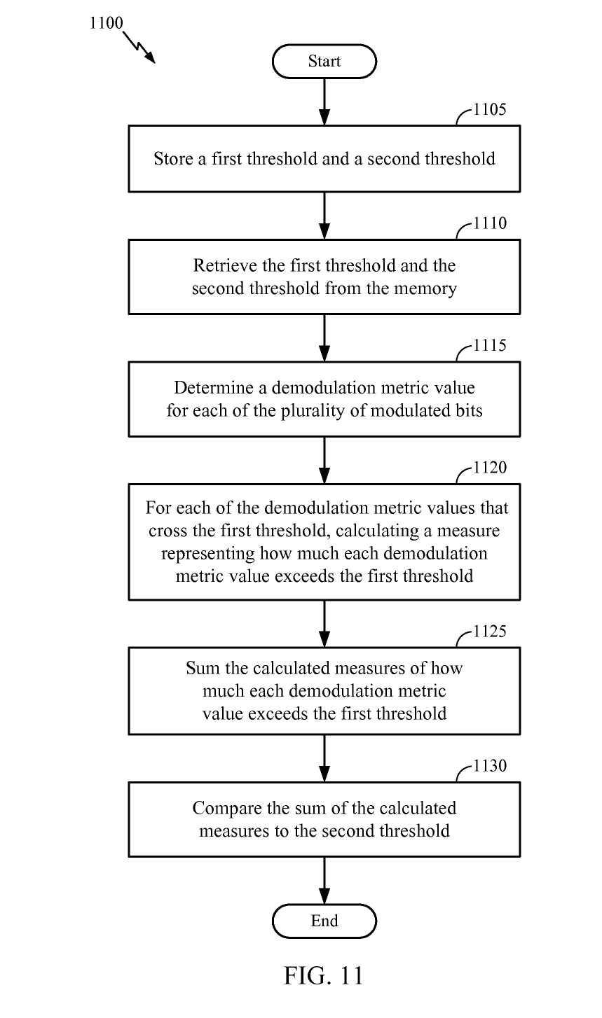

A process for detecting erroneous demodulated bits using a soft metric implementation is further described in reference to FIG. 11.

### Erroneous Demodulated Bit Detection for DPSK Demodulation

Similar to Gaussian Frequency-Shift Keying, the decision metric based on maximum likelihood (ML) criterion for Differential Phase-Shift Keying decision feedback demodulation (DFD) may be represented by

$$\begin{matrix}{\hat{X}}_{i} ( N ) = Re \{ Y * ( N - 1 ) r ( N ) {e}^{- j {a}_{i} ( N )} \} \\ = \vert Y * ( N - 1 ) r ( N ) \vert cos [ φ ( N ) - {a}_{i} ( N ) ]\end{matrix} \qquad ( 15 )$$

where Y*(N−1)r(N) is expressed in terms of its magnitude and angle φ(N). This is equivalent to maximization of cos [φ(N)−aᵢ(N)] over all possible values {(φ₁, φ₂, . . . , φ_{M}} that aᵢ (N) can take. Thus the value of aᵢ (N) that has the shortest distance with φ(N) must be chosen. We call this hard decision. Hence, the detection of aᵢ(N), namely c(N)=arg(Y*(N−1)r(N))|_{hard decision}.

### Where

$$\begin{matrix}\begin{matrix}Y ( N ) = {\sum }_{k = 0}^{N} {e}^{j ( {\sum }_{m = k + 1}^{N} c ( m ) )} r ( k ) \\ = {e}^{j c ( N )} Y ( N - 1 ) + r ( N )\end{matrix} \\ and & ( 16 ) \\ r ( N ) = {e}^{{jφ}_{0}} s ( N ) + \tilde{n} ( N ) , where s ( N ) = {e}^{j ( {\sum }_{m = 1}^{N} a ( m ) )} & ( 17 )\end{matrix}$$

Similar to Gaussian Frequency-Shift Keying, because of the DVGA and to avoid instances where Y(N) in Expression (16) blows up, forgetting factor α is introduced, and the decision feedback demodulation architecture for Differential Phase-Shift Keying can be expressed as

$$\begin{matrix}\{ \begin{matrix}Y ( N ) = α Y ( N - 1 ) {e}^{j c ( N )} + r ( N ) \\ c ( N ) = arg ( Y * ( N - 1 ) r ( N ) ) {\vert}_{hard decision}\end{matrix} \\ where & ( 18 ) \\ r ( N ) = {e}^{{jφ}_{0}} \tilde{s} ( N ) + {\tilde{n}}_{2} ( N ) , where \tilde{s} ( N ) = A {e}^{j ( {\sum }_{m = 1}^{N} a ( m ) )} & ( 19 )\end{matrix}$$

Let W(N)=Y*(N−1)r(N). In the noiseless condition and if c(m)=a(m), W(N) can be shown as

$$\begin{matrix}W ( N ) = {\sum }_{k = 0}^{N - 1} {α}^{N - 1 - k} {e}^{- j ( {\sum }_{m = k + 1}^{N - 1} a ( m ) )} r * ( k ) r ( N ) \\ = {A}^{2} {\sum }_{k = 0}^{N - 1} {α}^{N - 1 - k} {e}^{- j ( {\sum }_{m = k + 1}^{N - 1} a ( m ) )} {e}^{- j ( {\sum }_{m = 1}^{k} a ( m ) )} {e}^{j ( {\sum }_{m = 1}^{N} a ( m ) )} \\ = {A}^{2} {\sum }_{k = 0}^{N - 1} {α}^{N - 1 - k} {e}^{- j ( {\sum }_{m = k + 1}^{N - 1} a ( m ) )} {e}^{j ( {\sum }_{m = 1}^{N} a ( m ) )} \\ = {A}^{2} {\sum }_{k = 0}^{N - 1} {α}^{N - 1 - k} {e}^{j a ( N )}\end{matrix} \qquad ( 20 )$$

Since α<1, applying geometric series to Expression 20, it can be shown that

$$W ( N ) = {A}^{2} {e}^{j a ( N )} \frac{1 - {α}^{N}}{1 - α} \leq \frac{{A}^{2} {e}^{j a ( N )}}{1 - α} \qquad ( 21 )$$

Here, arg(W(N))=a(N), and hence the detection of aᵢ(N), namely C(N)=arg(W(N))|_{hard decision} as shown in Expression (18). If α of 0.65 is used for Differential Phase-Shift Keying decision feedback demodulation, W(N) in Expression (21) becomes

W(N)=0.3597e^{ja(N)}(1−0.65^{N})≦0.3597e^{ja(N)} (22)

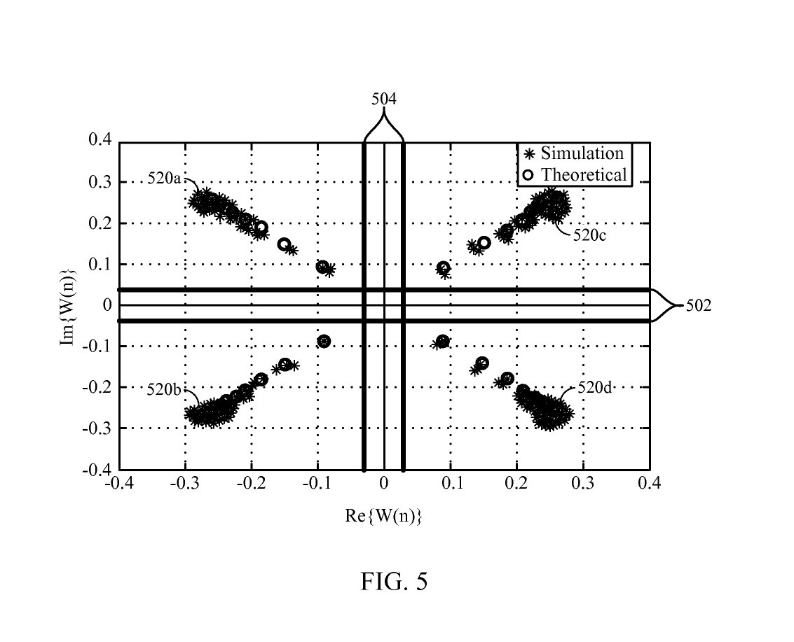

W(n) may be referred to as the demodulation metric for Differential Phase-Shift Keying (DPSK). FIG. 5 is a graphical depiction of simulation and theoretical results of Differential Phase-Shift Keying demodulation for W(N) in Expression (22). The example illustrated in FIG. 5 depicts W(n) for Differential Quaternary Phase-Shift Keying (DQPSK) at SNR equal 33 dB. In FIG. 5, 520a-d represent the demodulation metric values of a plurality of modulated bits, for example, in the payload of a Bluetooth packet. A first threshold 502, along the decision boundary Im{W(n)}=0, is illustrated in FIG. 5, and similarly a first threshold 504 is illustrated along the decision boundary Re{W(n)}=0. Using these first thresholds, in one implementation of demodulated bit error detection, the number of demodulation metric values that exceed the first threshold can be counted and then compared to a second threshold, similar to the process described in reference to FIG. 4. In another demodulated bit error detector implementation, the amount that demodulation metric values exceed the first threshold is first determined (or measured). Then, the measurements are added together and the summed measurements are compared to a second threshold. The presence of erroneous demodulated bits may be determined based on the comparison.

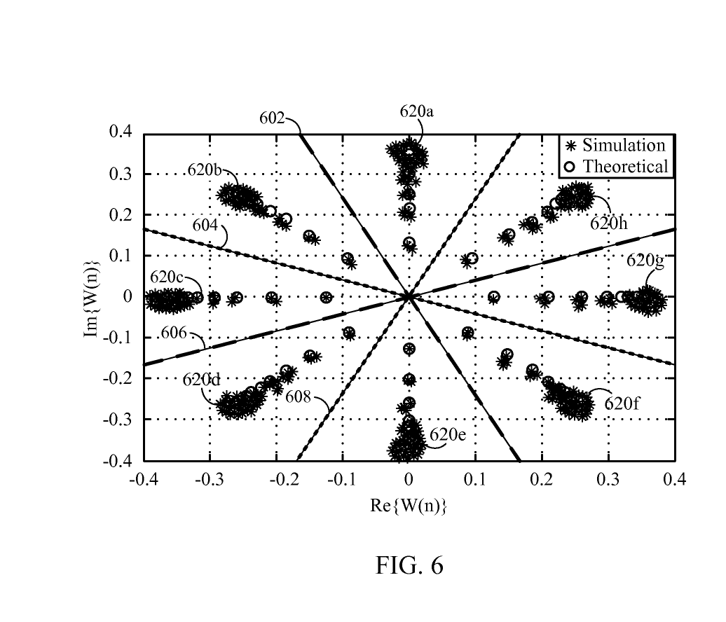

FIG. 6 is a graphical depiction of simulation and theoretical results of Differentially Encoded 8-Phase Shift Keying (D8PSK) demodulation for W(N) in Expression (22), in particular, depicting W(n) for D8PSK at SNR equal 33 dB. In D8QPSK, each transmitted symbol represents one of eight phase change states of the carrier, for example, 0, π/4, π/2, 3π/4, π, 5π/4, 3π/2, and 7π/4 radians. FIG. 6 illustrates threshold decision boundaries 602, 604, 606 and 608 around demodulation metric values 620a, 620b, 620c, 620d, 620e, 620f, 620g and 620h in the payload of a Bluetooth packet.

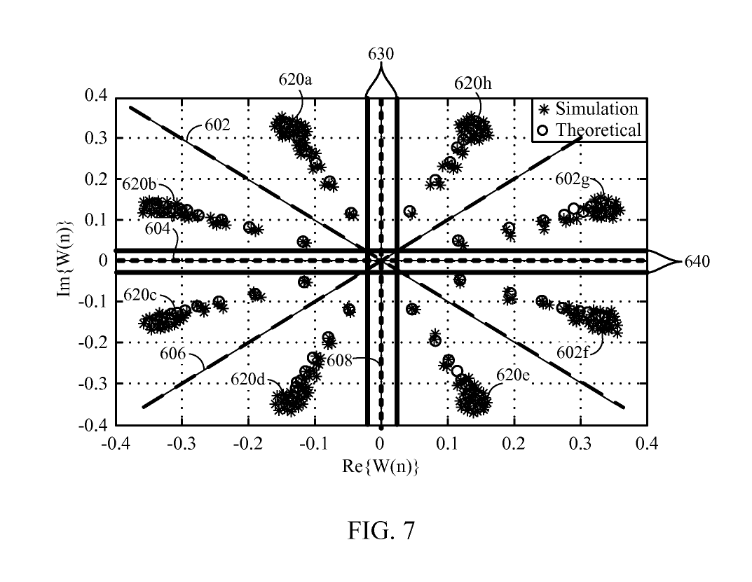

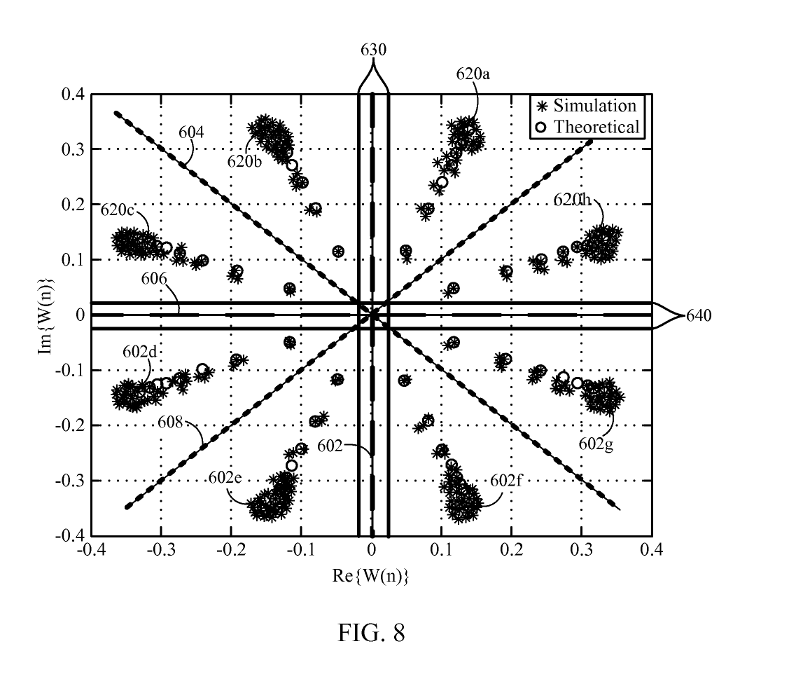

FIG. 7 is a graphical depiction of W(N) in Expression (22) rotated by π/8, in particular, depicting W(n) for Differentially Encoded 8-Phase Shift Keying at SNR equal 33 dB illustrated in FIG. 6 rotated by π/8 (that is, counterclockwise as depicted in FIG. 7). FIG. 8 is a graphical depiction of simulation and theoretical results of W(N) in Expression (22) rotated by −π/8 (that is, clockwise as depicted in FIG. 8), in particular, depicting W(n) for Differentially Encoded 8-Phase Shift Keying at SNR equal 33 dB illustrated in FIG. 6 rotated by −π/8. A first threshold 640, along the Im{W(n)}=0, is depicted, and similarly a first threshold 630, along the Re{W(n)}=0. In one implementation of detecting erroneous demodulated bits, the number of demodulation metric values that exceed the first threshold can be counted by rotating W(n) by π/8, comparing the rotated demodulation metric values with the first threshold, then rotating W(n) by −π/8 and comparing the rotated demodulation metric values with the first threshold again. This count of demodulation metric values exceeding the first threshold may be compared to a second threshold and if the total count is higher than the second threshold, the demodulated bits may be deemed to include erroneous demodulated bits.

In another implementation of detecting erroneous demodulated bits (for example, D8PSK), a process may include (or a circuit may be configured for) rotating the demodulation metric values W(n) by π/8 and comparing the rotated demodulation values with a first threshold. Then, the process may include rotating the demodulation metric values W(n) by −π/8 and comparing the rotated demodulation metric values with the first threshold again. For each rotated demodulation metric value that exceeds the first threshold, a measure may be calculated representing by how much each rotated demodulation metric value exceeds the first threshold. The calculated measures of how much each rotated demodulation metric value exceeds the first threshold can be added together (summed) to a resulting summed value. The summed value may be compared to the second threshold, to determine if the demodulated bits include erroneous demodulated bits.

An algorithm to detect erroneous demodulated bits for Differential Phase-Shift Keying using counting implementation can be shown by the following pseudo code. A process for detecting erroneous demodulated bits using a counting implementation is further described in reference to FIG. 10.

```
numErrorCounter = 0;
ErroneousBitDetected = false;
while (!endOfPacket)
{
  if (modType = DQPSK)
  {
    if ((abs(real(W(n))) <= DQSKErrorRegionThreshold)∥
        (abs(imag(W(n))) <= DQSKErrorRegionThreshold))
    {
      numErrorCounter++;
    }
    ErroneousBitDetected = (numErrorCounter > DQPSKNumError
    Threshold);
  }
  else if (modType = D8PSK)
  {
    Wp(n) = W(n)* [symbol]   (j*pi/8);
    Wn(n) = W(n)* [symbol]   (-j*pi/8);
    if ((abs(real(Wp(n))) <= D8SKErrorRegionThreshold)∥
        (abs(imag(Wp(n))) <= D8SKErrorRegionThreshold)∥
        (abs(real(Wn(n))) <= D8SKErrorRegionThreshold)∥
        (abs(imag(Wn(n))) <= D8SKErrorRe gionThreshold))
    {
      numErrorCounter++;
    }
    ErroneousBitDetected = (numErrorCounter > D8PSKNumError
    Threshold);
  }
}
```

The algorithm to detect erroneous demodulated bits for Differential Phase-Shift Keying using soft metric implementation can be shown by the following pseudo code. A process for detecting erroneous demodulated bits using a counting implementation is further described in reference to FIG. 11.

```
softErrorMetric = 0;
ErroneousBitDetected = false;
while (!endOfPacket)
{
  if (modType = DQPSK)
  {
    if (abs(real(W(n))) <= DQPSKErrorRegionThreshold)
    {
      softErrorMetric += (DQPSKErrorRegionThreshold −
      abs(real(W(n))));
    }
    else if (abs(imag(W(n))) <= DQSKErrorRegionThreshold)
    {
      softErrorMetric += (DQPSKErrorRegionThreshold −
      abs(imag(W(n))));
    }
    ErroneousBitDetected = (softErrorMetric >
    DQPSKSoftErrorThreshold);
  }
  else if (modType = D8PSK)
  {
    Wp(n) = W(n)* [symbol]   (j*pi/8);
    Wn(n) = W(n)* [symbol]   (−j*pi/8);
    if (abs(real(Wp(n))) <= D8PSKErrorRegionThreshold)
    {
      softErrorMetric += (D8PSKErrorRegionThreshold −
      abs(real(Wp(n))));
    }
    else if (abs(imag(Wp(n))) <= D8PSKErrorRegionThreshold)
    {
      softErrorMetric += (D8PSKErrorRegionThreshold −
      abs(imag(Wp(n))));
    }
    else if (abs(real(Wn(n))) <= D8PSKErrorRegionThreshold)
    {
      softErrorMetric += (D8PSKErrorRegionThreshold −
      abs(real(Wn(n))));
    }
    else if (abs(imag(Wn(n))) <= D8PSKErrorRegionThreshold)
    {
      softErrorMetric += (D8PSKErrorRegionThreshold −
      abs(imag(Wn(n))));
    }
    ErroneousBitDetected = (softErrorMetric >
    D8PSKSoftErrorThreshold);
  }
}
```

FIG. 9 is a schematic illustrating one example representation of an information packet that is communicated via a wireless communication system. As stated above, an erroneous payload header may cause more damage to the system than erroneous data in a payload. For example, greater data corruption may occur if the payload header is erroneous. To more accurately determine if a payload header is erroneous (for example, to lower false positives indicating the demodulated data is accurate when it is really erroneous) in some implementations an error detector can place more weight on the payload header than on the payload itself when evaluating a packet for erroneous data.

The example of an information packet schematically illustrated in FIG. 9 includes a payload header field 905, a payload field 910, and a cyclic redundancy check (CRC) field 915. In various implementations, the information packet may include more or less fields. The payload field 910 may be much larger than the payload header 905. However, the payload header 905 may contain important information relating to the payload 910, and if demodulation of the payload header 905 data is erroneous, the payload 910 may be misinterpreted even if its demodulation is completely successful. Accordingly, in some implementations the importance of successfully demodulating bits that are included in the payload header 905 is emphasized, for example, by being weighted when used in subsequent calculations. In other words, a certain number of the bits in the header may be weighted in various implementations.

For example, a technique can be implemented similar to that as described in reference to FIG. 4 where, for demodulated data that cresses a first threshold value, a measure is determined to represent by how much the demodulated data has exceeded the threshold, and the measures are added together and compared to a second threshold value. To reduce false positives of the demodulated payload header bits, the measure of how much the first threshold is exceeded can be weighted and the sum of the weighted measures can be compared to the second threshold value. For example, the measure can be multiplied by any number greater than one (e.g., 1.5, 2, 3, 4, 5 or 6, or a greater number, a whole number otherwise) to weight each measure. In one example, as shown in Table 1, the parameter that is used to set the weight that is applied for the bits in the header is pl_header_weight. In some implementations, the measure of all of the demodulated bits in the payload header 905 that exceed the first threshold are weighted and summed together. In other implementations, the measure of only a portion of the demodulated bits of the payload header 905 that exceed the first threshold are weighted. For example, a portion of the demodulation results of bits in the payload header 905 can be weighted. In some implementations, the demodulation results of bits in a portion of, or the whole payload header 905, are weighted, and demodulation results of bits in a portion of the payload 910 are weighted. In one example, as illustrated in Table 1, the parameter that is used to identify the portion of bits that are weighted is pl_header_length. In some implementations, the weight and/or the portion of bits that are weighted can be a programmable value set upon original configuration of the device (or processor) performing the demodulation process, set later during operation by a command communicated to device, or set by a feedback system that tunes the demodulation.

FIG. 10 is a flowchart that illustrates an example of a process 2000 for detecting the occurrence of erroneous demodulated bits in a plurality of modulated bits. Process 1000 may be implemented on any Bluetooth communication device, for example, the device 102a-c illustrated in FIG. 1. At block 1005, the process 1000 stores a first threshold value and a second threshold value in memory. For example, the memory 220 can be in a device 102 as illustrated in FIG. 2. The first and second threshold value can be done at any time. For example, during manufacturing or testing of a device having the memory, or be stored in memory during operation of the device. In some implementations, the first and second threshold are downloaded to the device before it is operational, and in other implementations after the device is operational. The first threshold value can provide information that is used to determine one or more boundaries that are used in an error detection method or system. Accordingly, the first threshold value can include information associated with one or more thresholds (graphically depicted as boundaries in FIGS. 4, 5, 6, 7 and 8. The second threshold value can be (or can represent) a threshold value relating to a number of erroneous bit values that exceed the first threshold.

At block 1010, the first threshold value and the second threshold value are retrieved from the memory. In some implementations, a processor retrieves the first and second threshold values, for example, processor 210 that is illustrated in FIG. 2. At block 1015 the process 1000 determines a demodulation metric value for each of the plurality of modulated bits. In some implementations, this can be performed by a processor such as processor 210 illustrated in FIG. 2. In other implementations, another computing device can perform this portion of the process 1000.

At block 1020, the process 1000 counts the number of demodulation metric values that exceed (or cross) the first threshold value. In some implementations, this can be performed by a processor such as processor 210 illustrated in FIG. 2. At block 1025, the number of demodulation metric values that exceeded the first threshold are compared to the second threshold value. If the number of demodulation metric values exceeds the second threshold value, the process 1000 may determine that the data is erroneous and request the erroneous data to be transmitted again. Comparing the count of the demodulation metric values that exceed the first threshold to the second threshold value can be referred to as using a “hard metric” for determining if there are erroneous demodulated bits.

FIG. 11 is a flowchart that illustrates an example of a process 2100 for detecting the occurrence of erroneous demodulated bits. The portions of the process 1100 that are similar to the process 1000 described in reference to FIG. 10 may also be implemented using structure described in reference to FIG. 10 (for example, memory 220, processor 210) and for clarity such structure may not be further described in reference to FIG. 11. At block 1105, the process 1100 stores a first threshold value and a second threshold value, for example, stores the first and second threshold value in memory. At block 1110 the process 1100 retrieves the first threshold and second threshold from the memory. At block 1115 the process 1100 determines a demodulation metric value for each of the plurality of modulated bits. At block 1120, the process 1100, for each of the demodulation metric values that cross the first threshold, calculates a measure representing how much each demodulation metric value exceeds the first threshold. At block 1125, process 1100 sums the calculated measures of how much each demodulation metric value exceeds the first threshold. And at block 1130, the process 1100 compares the sum of the calculated measures to the second threshold. If the sum of the calculated measures exceeds the second threshold, the process 1100 may determine that erroneous demodulated bit values exist and request such data be re-transmitted.

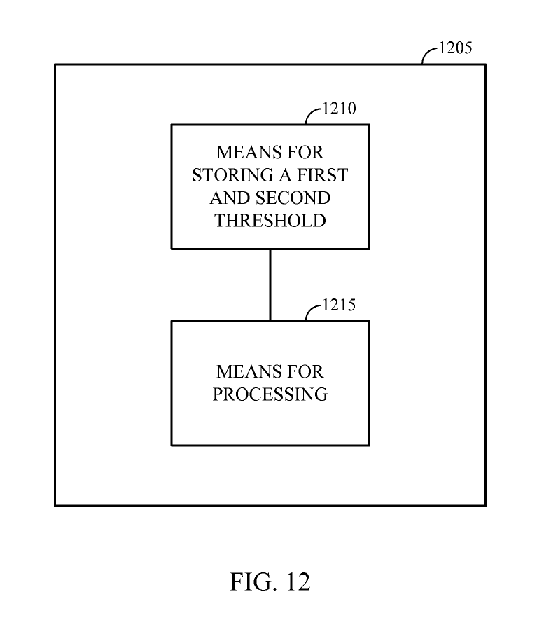

FIG. 12 illustrates a block diagram of an implementation of an apparatus 1205 for detecting demodulated bit errors of a plurality of modulated bits. The apparatus includes means for storing a first threshold and a second threshold 1210. The storing means can be any type of media or electronic memory component including and computer readable medium including computer storage media and communication media including any medium that facilitates transfer of a computer program from one place to another, or any available media that can be accessed by a computer (including but not limited to, for example, RAM, ROM, EEPROM, CD-ROM, or other optical disk storage, magnetic disk storage or other magnetic storage devices, or any other medium that can be used to carry or store desired program code in the form of instructions or data structures and that can be accessed by a computer. The apparatus can also include a means for processing 1215 coupled to the storing means 1210. The processing means 1215 may comprise a processor configured to retrieve the first threshold and second threshold from the storing means and to determine a demodulation metric value for each of the plurality of modulated bits, the processing means further configured to count the number of demodulation metric values that cross the first threshold and compare the second threshold to the number of demodulation metric values that cross the first threshold. The processing means 1215 may be further configured to determine if an error exists in the demodulated bits based on the comparison of the second threshold to the number of demodulation metric values that cross the first threshold. The modulated bits may be Gaussian Frequency-Shift Keying (GFSK) modulated bits, Differential Phase-Shift Keying (DPSK) modulated bits, Differential Quaternary Phase-Shift Keying (DQPSK) modulated bits, or a Differential Encoded 8-Phase Shift Keying (DQPSK) modulated bits. In some embodiments, the processing means is configured to retrieve the first threshold and second threshold from the storing means and determine a demodulation metric value for each of the plurality of modulated bits, the storing means further configured to, for demodulation metric values that cross the first threshold, calculate a measure representing how much each demodulation metric value exceeds the first threshold, sum the calculated measures, and compare the sum of the calculated measures to the second threshold.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of: A, B, or C” used in the description or the claims means “A or B or C or any combination of these elements.”

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. An apparatus for detecting demodulated bit errors of a plurality of modulated bits, comprising:
a memory component configured to store a first threshold and a second threshold; and
a processor coupled to the memory component, the processor configured to retrieve the first threshold and second threshold from the memory component and to determine a demodulation metric value for each of the plurality of modulated bits, the processor further configured to count the number of demodulation metric values that cross the first threshold and compare the second threshold to the number of demodulation metric values that cross the first threshold.

2. The apparatus of claim 1, wherein the processor is further configured to identify that an error exists in the demodulated bits if the number of demodulation metric values that cross the first threshold exceeds the second threshold.

3. The apparatus of claim 1, wherein the modulated bits are one of Gaussian Frequency-Shift Keying (GFSK) modulated bits, Differential Phase-Shift Keying (DPSK) modulated bits, Differential Quaternary Phase-Shift Keying (DQPSK) modulated bits, or Differential Encoded 8-Phase Shift Keying (D8PSK) modulated bits.

4. The apparatus of claim 1, wherein the processor is further configured to weight the number of demodulation metric values that exceed the first threshold for bits in the plurality of modulated bits that form at least a portion of a header of communicated information represented by the plurality of modulated bits.

5. An apparatus for detecting demodulated bit errors of a plurality of modulated bits, comprising:
a memory component configured to store a first threshold and a second threshold; and
a processor coupled to the memory component, the processor configured to retrieve the first threshold and second threshold from the memory component and determine a demodulation metric value for each of the plurality of modulated bits, the processor further configured to, for demodulation metric values that cross the first threshold, calculate a measure representing how much each demodulation metric value exceeds the first threshold, sum the calculated measures, and compare the sum of the calculated measures to the second threshold.

6. The apparatus of claim 5, wherein the processor is further configured to identify that an error exists in the demodulated bits if the sum of the calculated measures of the demodulation metric values that cross the first threshold is greater than the second threshold.

7. The apparatus of claim 5, wherein the modulated bits are one of Gaussian Frequency-Shift Keying (GFSK) modulated bits, Differential Phase-Shift Keying (DPSK) modulated bits, Differential Quaternary Phase-Shift Keying (DQPSK) modulated bits, or Differential Encoded 8-Phase Shift Keying (D8PSK) modulated bits.

8. The apparatus of claim 5, wherein the processor is further configured to weight the measure for demodulation metric values that exceed the first threshold for bits in the plurality of bits that form at least a portion of a header of communicated information that includes the plurality of bits.

9. A method for detecting a demodulated bit error of a plurality of modulated bits, the method comprising:
storing a first threshold and a second threshold in memory;
retrieving the first threshold and the second threshold from the memory component;
determining a demodulation metric value for each of a plurality of modulated bits;
counting the number of demodulation metric values that cross the first threshold; and
comparing the second threshold to the number of demodulation metric values that cross the first threshold.

10. The method of claim 9, further comprising identifying a demodulated bit error if the number of demodulation values that cross the first threshold exceeds the second threshold.

11. The method of claim 9, wherein determining a demodulation metric value for each of the plurality of modulated bits includes using one of Gaussian Frequency-Shift Keying (GFSK) demodulation, Differential Phase-Shift Keying (DPSK) demodulation Differential Quaternary Phase-Shift Keying (DQPSK) demodulation, or Differential Encoded 8-Phase Shift Keying (D8PSK) demodulation.

12. The method of claim 9, further comprising weighting the number of demodulation metric values that exceed the first threshold for bits in the plurality of bits that form at least a portion of a header of communicated information that includes the plurality of bits more than other of the plurality of demodulation metric values.

13. A method for detecting a demodulated bit error of a plurality of modulated bits received in a communication of information, the method comprising:
storing a first threshold and a second threshold; and
retrieving the first threshold and second threshold from a memory component;
determining a demodulation metric value for each of the plurality of modulated bits;
for each of the demodulation metric values that cross the first threshold, calculating a measure representing how much each demodulation metric value exceeds the first threshold;
summing the calculated measures of how much each demodulation metric value exceeds the first threshold; and
comparing the sum of the calculated measures to the second threshold.

14. The method of claim 13, further comprising identifying a demodulated bit error if the sum of the calculated measures exceeds the second threshold.

15. The method of claim 13, further comprising weighting the measure for demodulation metric values that exceed the first threshold for bits in the plurality of bits that form at least a portion of a header of communicated information that includes the plurality of bits.

16. A computer readable medium comprising instructions that, when executed, cause an apparatus to perform a method for detecting demodulated bit errors of a plurality of modulated bits, the method comprising:
storing a first threshold and a second threshold in memory; and
retrieving the first threshold and the second threshold from the memory;
determining a demodulation metric value for each of the plurality of modulated bits;
counting the number of demodulation metric values that cross the first threshold;
comparing the second threshold to the number of demodulation metric values that cross the first threshold; and
identifying that an error exists in the demodulated bits if the number of demodulation metric values that cross the first threshold exceeds the second threshold.

17. The computer readable medium of claim 16, wherein the modulated bits are one of Gaussian Frequency-Shift Keying (GFSK) modulated bits, Differential Phase-Shift Keying (DPSK) modulated bits, Differential Quaternary Phase-Shift Keying (DQPSK) modulated bits, or Differential Encoded 8-Phase Shift Keying (D8PSK) modulated bits.

18. The computer readable medium of claim 16, wherein the method further comprises weighting the number of demodulation metric values that exceed the first threshold for bits in the plurality of modulated bits that form at least a portion of a header of communicated information represented by the plurality of modulated bits.

19. A computer readable medium comprising instructions that, when executed, cause an apparatus to perform a method for detecting demodulated bit errors of a plurality of modulated bits, the method comprising:
storing a first threshold and a second threshold; and
retrieving the first threshold and second threshold from memory;
determining a demodulation metric value for each of the plurality of modulated bits;
for each of the demodulation metric values that cross the first threshold, calculating a measure representing how much each demodulation metric value exceeds the first threshold;
summing the calculated measures of how much each demodulation metric value exceeds the first threshold;
comparing the sum of the calculated measures to the second threshold; and
identifying that an error exists in the demodulated bits if the sum of the calculated measures of the demodulation metric values that cross the first threshold is greater than the second threshold

20. The computer readable medium of claim 19, wherein the modulated bits are one of Gaussian Frequency-Shift Keying (GFSK) modulated bits, Differential Phase-Shift Keying (DPSK) modulated bits, Differential Quaternary Phase-Shift Keying (DQPSK) modulated bits, or Differential Encoded 8-Phase Shift Keying (D8PSK) modulated bits.

21. The computer readable medium of claim 19, wherein the method further comprises weighting the measure for demodulation metric values that exceed the first threshold for bits in the plurality of bits that form at least a portion of a header of communicated information that includes the plurality of bits.

22. An apparatus for detecting demodulated bit errors of a plurality of modulated bits, comprising:
means for storing a first threshold and a second threshold; and
means for processing coupled to the storing means, the processing means configured to retrieve the first threshold and second threshold from the storing means and to determine a demodulation metric value for each of the plurality of modulated bits, the processing means further configured to count the number of demodulation metric values that cross the first threshold and compare the second threshold to the number of demodulation metric values that cross the first threshold.

23. The apparatus of claim 22, wherein the processing means is further configured to determine if an error exists in the demodulated bits based on the comparison of the second threshold to the number of demodulation metric values that cross the first threshold.

24. The apparatus of claim 22, wherein the modulated bits are one of Gaussian Frequency-Shift Keying (GFSK) modulated bits, Differential Phase-Shift Keying (DPSK) modulated bits, Differential Quaternary Phase-Shift Keying (DQPSK) modulated bits, or a Differential Encoded 8-Phase Shift Keying (D8PSK) modulated bits.

25. The apparatus of claim 22, wherein the storing means comprises a memory component.

26. The apparatus of claim 22, wherein the processing means comprises a processor.

27. An apparatus for detecting demodulation bit errors of a plurality of modulated bits, comprising:
a means for storing a first threshold and a second threshold; and
a means for processing coupled to the storing means, the processing means configured to retrieve the first threshold and second threshold from the storing means and determine a demodulation metric value for each of the plurality of modulated bits, the storing means further configured to, for demodulation metric values that cross the first threshold, calculate a measure representing how much each demodulation metric value exceeds the first threshold, sum the calculated measures, and compare the sum of the calculated measures to the second threshold.

28. The apparatus of claim 27, wherein the storing means comprises a memory component.

29. The apparatus of claim 27, wherein the processing means is further configured to identify that an error exists in the demodulated bits if the number of demodulation metric values that cross the first threshold exceeds the second threshold.

30. The apparatus of claim 27, wherein the modulated bits are one of Gaussian Frequency-Shift Keying (GFSK) modulated bits, Differential Phase-Shift Keying (DPSK) modulated bits, Differential Quaternary Phase-Shift Keying (DQPSK) modulated bits, or Differential Encoded 8-Phase Shift Keying (D8PSK) modulated bits.

31. The apparatus of claim 27, wherein the processing means is further configured to weight the number of demodulation metric values that exceed the first threshold for bits in the plurality of modulated bits that form at least a portion of a header of communicated information represented by the plurality of modulated bits.

32. The apparatus of claim 27, wherein the processing means comprises a processor.
